(19) United States
(12) Patent Application Publication
(10) Pub. No.: US 2017/0187829 A1
(43) Pub. Date: Jun. 29, 2017

(54) APPLICATION MANAGEMENT METHOD AND DEVICE

(71) Applicant: Xiaomi Inc., Beijing (CN)

(72) Inventors: Zifeng QIU, Beijing (CN); Jiping MA, Beijing (CN); Qiwu HUANG, Beijing (CN)

(73) Assignee: Xiaomi Inc.

(21) Appl. No.: 15/381,176

(22) Filed: Dec. 16, 2016

(30) Foreign Application Priority Data
Dec. 28, 2015 (CN) 201511001515.4

(51) Int. Cl. H04L 29/08; H04L 12/24

(52) U.S. Cl. CPC H04L 67/325; H04L 67/327; H04L 41/0654; H04L 67/303; H04W 52/0229

(57) ABSTRACT

The present disclosure relates to an application management method and device, and belongs to the technical field of computers. The method includes: receiving a first message of a first application, and displaying a first notice corresponding to the first message; interrupting network communication of the first application if a reading instruction for any message of the first application is not received within a first preset duration after the first message is received; and recovering network communication of the first application when a preset interruption cancellation triggering event is detected. By the present disclosure, power of a terminal may be saved.

### CROSS-REFERENCE TO RELATED APPLICATIONS

This application is based upon and claims priority to Chinese Patent Application No. 201511001515.4, filed on Dec. 28, 2015, the entire contents of which are incorporated herein by reference.

### TECHNICAL FIELD

The embodiments of the present disclosure generally relate to the technical field of computers, and more particularly, to an application management method and device.

### BACKGROUND

Along with rapid development of computer technology, terminals such as a mobile phone have spread to all corners of the world, and more and more applications have also been developed and used correspondingly.

After a terminal receives a certain message (such as an advertisement message) sent by a server through a locally installed application, the terminal may display a notice corresponding to the message to prompt a user to click and view the message.

In a process of implementing the present disclosure, the inventor found that there is at least the following problem in related arts:
a terminal frequently receives messages of applications and displays corresponding notices, which may cause high power consumption of the terminal.

### SUMMARY

According to a first aspect of the embodiments of the present disclosure, there is provided an application management method, including: receiving a first message of a first application, and displaying a first notice corresponding to the first message; interrupting network communication of the first application if a reading instruction for any message of the first application is not received within a first preset duration after the first message is received; and recovering network communication of the first application when a preset interruption cancellation triggering event is detected.

According to a second aspect of the embodiments of the present disclosure, there is provided an application management device, including: a processor; and a memory for storing instructions executable by the processor. The processor is configured to: receive a first message of a first application, and display a first notice corresponding to the first message; interrupt network communication of the first application if a reading instruction for any message of the first application is not received within a first preset duration after the first message is received; and recover network communication of the first application when a preset interruption cancellation triggering event is detected.

According to a third aspect of the embodiment of the disclosure, there is provided a non-transitory computer-readable storage medium having stored therein instructions that, when executed by a processor, cause the processor to perform an application management method, the method comprising: receiving a first message of a first application, and displaying a first notice corresponding to the first message; interrupting network communication of the first application if a reading instruction for any message of the first application is not received within a first preset duration after the first message is received; and recovering network communication of the first application when a preset interruption cancellation triggering event is detected.

It is to be understood that both the foregoing general description and the following detailed description are exemplary and explanatory only and are not restrictive of the embodiment of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of embodiments of the present disclosure. In the drawings:

FIG. 1 is a flow chart showing an application management method, according to an exemplary embodiment;

FIG. 2 is a flow chart showing application management, according to an exemplary embodiment;

FIG. 3 is a schematic diagram of an application management device, according to an exemplary embodiment;

FIG. 4 is a schematic diagram of an application management device, according to an exemplary embodiment;

FIG. 5 is a schematic diagram of an application management device, according to an exemplary embodiment; and

FIG. 6 is a structural diagram of a terminal, according to an exemplary embodiment.

The specific embodiments of the disclosure are shown through the above accompanying drawings, and more detailed description will be given hereinafter. These accompanying drawings and text description do not limit the scope of conception of the disclosure in any way, but illustrate concepts of the disclosure for the skilled personnel in the field by referring to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

An exemplary embodiment of the present disclosure provides an application management method, which may be adopted for a terminal. The terminal may be any mobile terminal installed with an application, such as a mobile phone and a tablet computer. A processor, a memory, a screen, an input unit, and a communication part may be arranged in the terminal. The processor is configured to process a process of managing the application. The memory is configured to store required data and generated data in the processing process. The screen is configured to display content required to be displayed to a user in the processing process, such as a message of the application. The input unit is configured for the user to input an instruction to the terminal or set information, such as a keyboard and a microphone (MIC). The communication part is configured to receive or send data involved in the processing process, such as a BlueTooth (BT) part and an antenna. In the embodiment, the solution will be described with the condition that the terminal is a mobile phone as an example in detail, and other conditions are similar, and will not be elaborated in the embodiment.

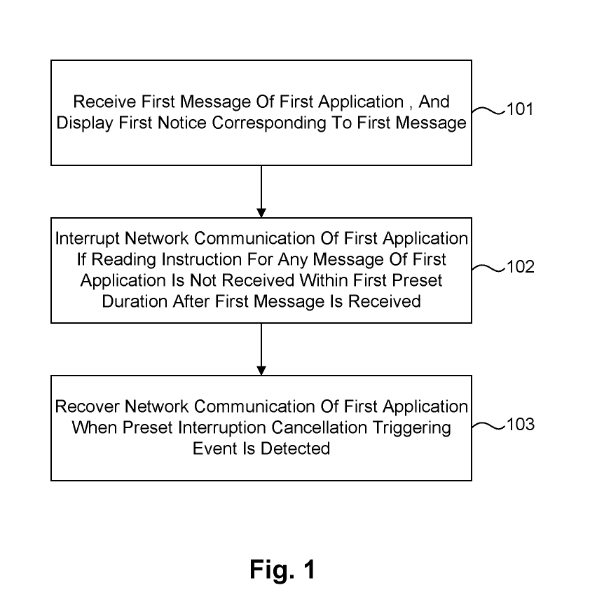

A process flow shown in FIG. 1 will be described below with reference to an implementation mode in detail.

In Step 101, a first message of a first application is received, and a first notice corresponding to the first message is displayed.

During implementation, a user may install various applications on a terminal. Most of the applications may often send some messages to a system of the terminal. After receiving a message of a certain application, i.e., the first message of the first application, the terminal directly displays the first message in a screen or generates the first notice corresponding to the first message and displays the first notice.

In Step 102, network communication of the first application is interrupted if a reading instruction for any message of the first application is not received within a first preset duration after the first message is received.

During implementation, the terminal starts timing and monitors the reading instruction from the user for any message of the first application after receiving the first message. If the terminal does not receive the reading instruction for any message of the first application within the first preset duration, it determines that the message of the first application is currently not required to be timely acquired, so that network communication of the first application may be interrupted, and the first application may enter an off state and not receive any message. For example, after receiving a chat message from a messaging application, the terminal displays a notice of the chat message, and if the user does not click any message of the messaging application within 5 minutes, including the chat message, a push message, and news, network communication of the messaging application is interrupted.

In Step 103, the network communication of the first application is recovered when a preset interruption cancellation triggering event is detected.

During implementation, after network communication of the first application is interrupted, the terminal monitors whether the preset interruption cancellation triggering event happens or not in real time. If occurrence of the preset interruption cancellation triggering event is detected, network communication of the first application is recovered, and the first application further continues receiving messages.

In some embodiments, it may be set that the application is controlled to be connected to a network only after the terminal enters a standby state. Correspondingly, the process of Step 102 may be implemented as follows: network communication of the first application is interrupted if the terminal is in the standby state when receiving the first message and if the reading instruction for any message of the first application is not received within the first preset duration after the first message is received.

During implementation, the terminal may acquire a notice about an on/off state of the screen from a system log service process, and whether the terminal is in the standby state or not is determined according to the on/off state of the screen. The process in Step 102 is triggered if the screen is in the off state when the terminal receives the first message, and the network connection of the first application is not controlled if the screen is in the on state when the terminal receives the first message.

In some embodiments, the preset interruption cancellation triggering event in Step 103 may be diversified, and two possible interruption cancellation triggering events are given below.

Event 1: network communication of the first application is recovered after the reading instruction for any message of the first application is received.

During implementation, after the terminal interrupts a network connection of the first application, if the user clicks to read a certain message of the first application or enters any interface of the first application, the terminal may receive the reading instruction about the first application, and may further recover network communication of the first application.

Event 2: network communication of the first application is recovered after a second preset duration elapses after network communication of the first application is interrupted.

During implementation, the terminal may preset a triggering time for recovery of network communication. That is, the terminal automatically recovers network communication of the first application after the second preset duration elapses after interrupting the network connection of the first application. In the example in Step 102, it may be set that the terminal automatically recovers network communication of the messaging application after network communication of the messaging application is interrupted for 15 minutes.

In some embodiments, after network communication is recovered, the network connection of the application may be interrupted again when an interruption triggering event is detected. A corresponding process may be implemented as follows: network communication of the first application is interrupted again if a reading instruction for any message of the first application is not received within a third preset duration after network communication of the first application is recovered.

During implementation, timing may be started after network communication of the first application is recovered, and if the reading instruction from the user for any message of the first application is still not received within the third preset duration, network communication of the first application may be interrupted again. For example, whether the user clicks and reads a related message of a messaging application within 5 minutes after network communication of the messaging application is recovered or not may be detected, and if a reading instruction about the messaging application is not received within 5 minutes, network communication of the messaging application may be interrupted again.

In some embodiments, a disconnected state may be kept for a longer time when the network connection of the application is interrupted again, and corresponding process may be implemented as follows: network communication of the first application is recovered after a fourth preset duration elapses after network communication of the first application is interrupted again, wherein the fourth preset duration is longer than or equal to the second preset duration.

During implementation, the terminal may preset a triggering time for secondary recovery of network communication. That is, it may be set that network communication of the first application is recovered after the fourth preset duration elapses after the terminal interrupts network communication of the first application again, wherein the fourth preset duration may be set to be longer than or equal to the second preset duration. In the above-mentioned example, the messaging application is disconnected again, and it may be set that network communication of the messaging application is recovered after 30 minutes.

The whole application management flow may be implemented as follows.

The terminal keeps network communication of the first application within a first preset network connection duration after receiving the first message of the first application, interrupts network communication of the first application within a first preset network disconnection duration, recovers and keeps network communication of the first application for a second preset network connection duration, and continues interrupting network communication of the first application for a second preset network disconnection duration. The terminal executes a subsequent process in the same manner. The network disconnection durations may be kept unchanged or progressively increased, and the network connection durations may be kept unchanged or progressively decreased. When a certain network disconnection duration reaches a preset maximum or a certain network connection duration reaches a preset minimum, the terminal stops the application management flow and recovers to a state before the first message is received. Alternatively, the terminal continues the flow and keeps the network disconnection duration be the maximum or keep the network connection duration be the minimum. In addition, the terminal may stop the application management flow and may be recovered to the state before the first message is received when the terminal receives the reading instruction for any message of the first application.

The above-mentioned messaging application is taken as an example, and the other conditions are similar and will not be elaborated.

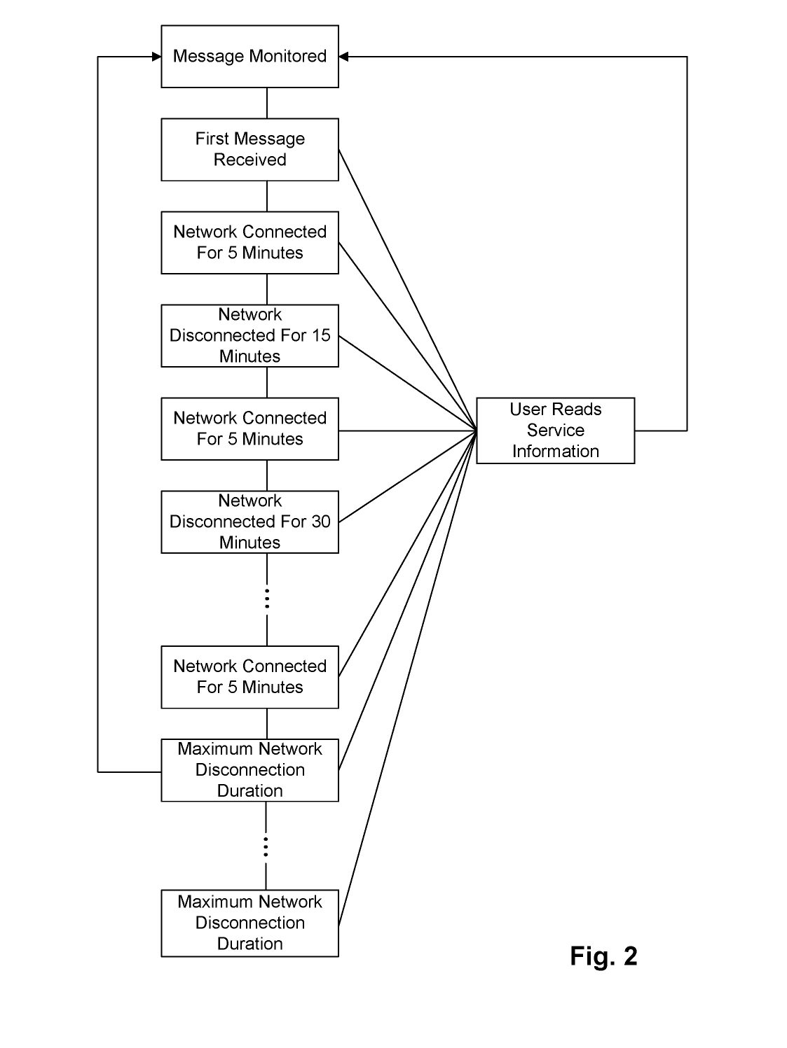

FIG. 2 shows an optional process flow according to an exemplary embodiment of the present disclosure. In the example, the terminal sets a network connection time of 5 minutes after receiving a message from the messaging application, interrupts the network connection of the messaging application for 15 minutes if the user does not read any message of the messaging application within 5 minutes, sets a network connection time of 5 minutes again, and interrupts the network connection of the messaging application for 30 minutes if the user still does not read any message of the messaging application within 5 minutes. The terminal performs the process in the same manner of keeping the network connection for 5 minutes and then interrupting the network connection. The network disconnection duration may be progressively increased until reaching a preset maximum duration. In addition, in the flow, if the user clicks a message from the messaging application, the process flow may be re-executed from an initial link. In addition, after the network disconnection duration reaches the maximum duration, the process flow may also be re-executed from an initial link. Each network connection time may also be correspondingly regulated according to a specific scenario.

In some embodiments, applications may be classified, and when network communication of a certain application is interrupted, other applications of the same type may be simultaneously interrupted. A corresponding process may be implemented as follows: a first application type of the first application is determined; and network communication of the first application and network communication of another application of the first application type is interrupted if a reading instruction for any message of the first application and a reading instruction for any message of the other application of the first application type are not received within the first preset duration after the first message is received.

During implementation, the terminal may classify locally installed applications. For example, the terminal may specifically classify the applications into a chat type, a shopping type, a video type, and a game type. If the terminal receives a message of a certain application of a certain application type, i.e. the first message, and does not receive a reading instruction from the user for any other message corresponding to applications of the certain application type within the first preset duration, network communication of all the locally installed applications of the certain application type is interrupted. For example, in the example of a messaging application, the messaging application may be classified as a chat type application, and chat type applications may further include other applications. The terminal detects whether a reading instruction for any message of the chat type applications is received or not within the next 5 minutes, and may interrupt network communication of all the locally installed chat type applications if the reading instruction for any message of the chat type applications is not received within 5 minutes.

In the embodiment of the present disclosure, the first message of the first application is received, the first notice corresponding to the first message is displayed, network communication of the first application is interrupted if the reading instruction for any message of the first application is not received within the first preset duration after the first message is received, and network communication of the first application is recovered when the preset interruption cancellation triggering event is detected. In such a manner, when the user does not need to read a message of a certain application, the terminal may interrupt network communication of the application, preventing reception of messages of the application and further preventing display of a corresponding notice, so that power of the terminal may be saved.

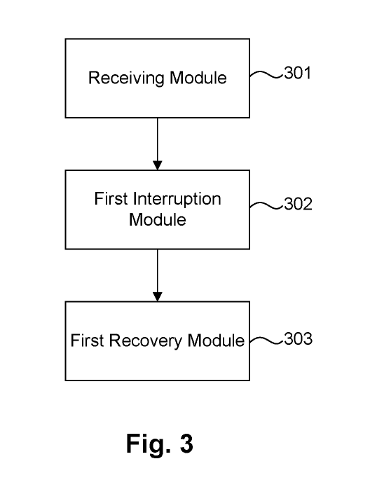

Based on the same technical concept, another exemplary embodiment of the present disclosure provides an application management device. As shown in FIG. 3, the device includes: a receiving module 301, configured to receive a first message of a first application, and display a first notice corresponding to the first message; a first interruption module 302, configured to interrupt network communication of the first application if a reading instruction for any message of the first application is not received within a first preset duration after the first message is received; and a first recovery module 303, configured to recover network communication of the first application when a preset interruption cancellation triggering event is detected.

In some embodiments, the first interruption module 302 is configured to: interrupt network communication of the first application if a terminal is in a standby state when receiving the first message and if the reading instruction for any message of the first application is not received within the first preset duration after the first message is received.

In some embodiments, the first recovery module 303 is configured to: recover network communication of the first application after the reading instruction for any message of the first application is received.

In some embodiments, the first recovery module 303 is configured to: recover network communication of the first application after a second preset duration elapses after network communication of the first application is interrupted.

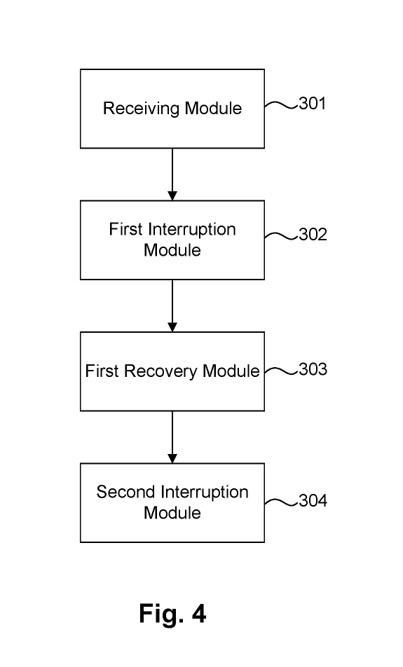

In some embodiments, as shown in FIG. 4, the device further includes: a second interruption module 304, configured to interrupt network communication of the first application again if a reading instruction for any message of the first application is not received within a third preset duration after network communication of the first application is recovered.

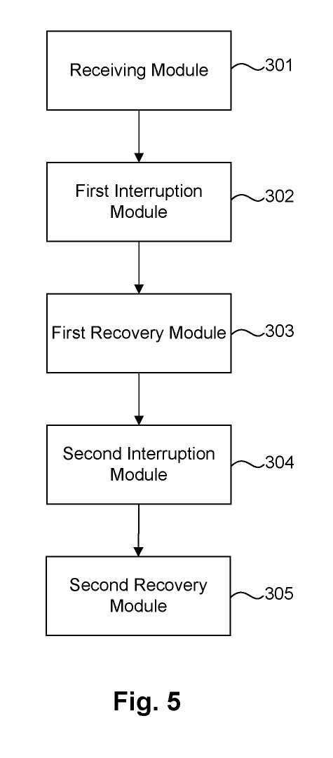

In some embodiments, as shown in FIG. 5, the device further includes: a second recovery module 305, configured to recover network communication of the first application after a fourth preset duration elapses after network communication of the first application is interrupted again, wherein the fourth preset duration is longer than or equal to the second preset duration.

In some embodiments, the first interruption module 302 is configured to: determine a first application type of the first application; and interrupt network communication of the first application and network communication of another application of the first application type if the reading instruction for any message of the first application and a reading instruction for any message of the other application of the first application type are not received within the first preset duration after the first message is received.

With respect to the devices in the above embodiments, the specific manners for performing operations for individual modules therein have been described in detail in the embodiments regarding the methods, which will not be elaborated herein.

In the embodiment of the present disclosure, the first message of the first application is received, the first notice corresponding to the first message is displayed, network communication of the first application is interrupted if the reading instruction for any message of the first application is not received within the first preset duration after the first message is received, and network communication of the first application is recovered when the preset interruption cancellation triggering event is detected. In such a manner, when the user does not need to read a message of a certain application, the terminal may interrupt network communication of the application, preventing reception of the message of the application and further preventing display of a corresponding notice, so that power of the terminal may be saved.

During application management of the application management device provided by the embodiment, descriptions are made only with division of each function module as an example, and during a practical application, functions may be allocated to different function modules for realization according to a requirement, that is, an internal structure of the device is divided into different function modules to realize all or part of the abovementioned functions. In addition, the application management device provided by the embodiment belongs to the same concept as the application management method embodiment, and details about its specific implementation process correspond to the method embodiment, and will not be elaborated herein.

Another exemplary embodiment of the present disclosure provides a structural diagram of a terminal. The terminal may be a mobile phone or the like.

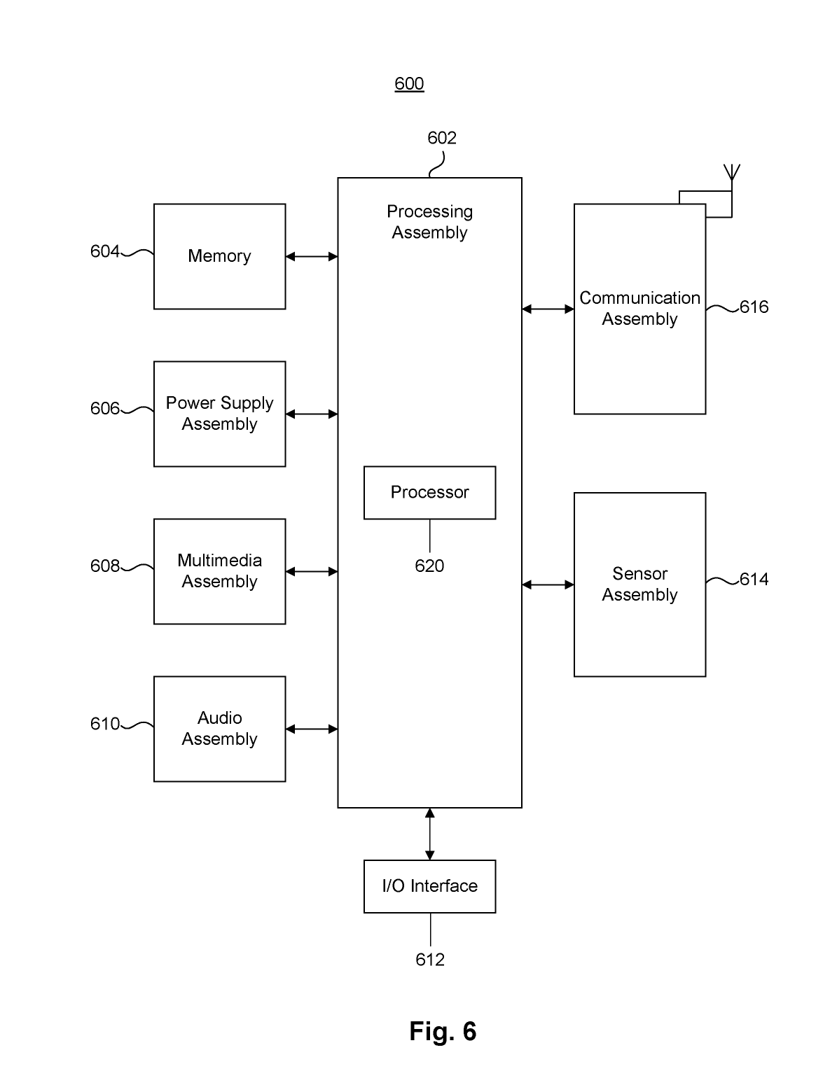

Referring to FIG. 6, the terminal 600 includes one or more of the following assemblies: a processing assembly 602, a memory 604, a power supply assembly 606, a multimedia assembly 608, an audio assembly 610, an Input/Output (I/O) interface 612, a sensor assembly 614, and a communication assembly 616.

The processing assembly 602 typically controls overall operations of the terminal 600, such as the operations associated with display, telephone calls, data communications, camera operations, and recording operations. The processing assembly 602 may include one or more processors 620 to execute instructions to perform all or part of the steps in the abovementioned method. Moreover, the processing assembly 602 may include one or more modules which facilitate interaction between the processing assembly 602 and the other assemblies. For instance, the processing assembly 602 may include a multimedia module to facilitate interaction between the multimedia assembly 608 and the processing assembly 602.

The memory 604 is configured to store various types of data to support the operation of the terminal 600. Examples of such data include instructions for any applications or methods operated on the terminal 600, contact data, phonebook data, messages, pictures, video, etc. The memory 604 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power supply assembly 606 provides power for various assemblies of the terminal 600. The power supply assembly 606 may include a power management system, one or more power supplies, and other assemblies associated with the generation, management and distribution of power for the terminal 600.

The multimedia assembly 608 includes a screen providing an output interface between the terminal 600 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia assembly 608 includes a front camera and/or a rear camera. The front camera and/or the rear camera may receive external multimedia data when the terminal 600 is in an operation mode, such as a photographing mode or a video mode. Each of the front camera and the rear camera may be a fixed optical lens system or have focusing and optical zooming capabilities.

The audio assembly 610 is configured to output and/or input an audio signal. For example, the audio assembly 610 includes a a microphone (“MIC”), and the MIC is configured to receive an external audio signal when the terminal 600 is in the operation mode, such as a call mode, a recording mode and a voice recognition mode. The received audio signal may be further stored in the memory 604 or sent through the communication assembly 616.

The I/O interface 612 provides an interface between the processing assembly 602 and a peripheral interface module, and the peripheral interface module may be a keyboard, a click wheel, a button and the like. The button may include, but is not limited to: a home button, a volume button, a starting button and a locking button.

The sensor assembly 614 includes one or more sensors configured to provide status assessment in various aspects for the terminal 600. For instance, the sensor assembly 614 may detect an on/off status of the terminal 600 and relative positioning of assemblies, such as a display and small keyboard of the terminal 600, and the sensor assembly 614 may further detect a change in a position of the terminal 600 or an assembly of the terminal 600, presence or absence of contact between the user and the terminal 600, orientation or acceleration/deceleration of the terminal 600 and a change in temperature of the terminal 600. The sensor assembly 614 may include a proximity sensor configured to detect presence of an object nearby without any physical contact. The sensor assembly 614 may also include a light sensor, such as a Complementary Metal Oxide Semiconductor (CMOS) or Charge Coupled Device (CCD) image sensor, configured for use in an imaging application. In some embodiments, the sensor assembly 614 may also include an acceleration sensor, a gyroscope sensor, a magnetic sensor, a pressure sensor or a temperature sensor.

The communication assembly 616 is configured to facilitate wired or wireless communication between the terminal 600 and another device. The terminal 600 may access a communication-standard-based wireless network, such as a Wireless Fidelity (WiFi) network, a 2nd-Generation (2G), 3rd-Generation (3G), or 4th-Generation (4G) network, or a combination thereof. In an exemplary embodiment, the communication assembly 616 receives a broadcast signal or broadcast associated information from an external broadcast management system through a broadcast channel. In an exemplary embodiment, the communication assembly 616 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the terminal 600 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic assemblies, and is configured to execute the abovementioned method.

In an exemplary embodiment, there is also provided a non-transitory computer-readable storage medium including an instruction, such as the memory 604 including an instruction, and the instruction may be executed by the processor 620 of the terminal 600 to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, an instruction in the storage medium is executed by a processor of a terminal to enable the terminal to execute an application management method, which includes: receiving a first message of a first application, and displaying a first notice corresponding to the first message; interrupting network communication of the first application if a reading instruction for any message of the first application is not received within a first preset duration after the first message is received; and recovering network communication of the first application when a preset interruption cancellation triggering event is detected.

In some embodiments, the step of interrupting network communication of the first application if the reading instruction for any message of the first application is not received within the first preset duration after the first message is received includes: interrupting network communication of the first application if the terminal is in a standby state when receiving the first message and if the reading instruction for any message of the first application is not received within the first preset duration after the first message is received.

In some embodiments, the step of recovering network communication of the first application when the preset interruption cancellation triggering event is detected includes: recovering network communication of the first application after the reading instruction for any message of the first application is received.

In some embodiments, the step of recovering network communication of the first application when the preset interruption cancellation triggering event is detected includes: recovering network communication of the first application after a second preset duration elapses after network communication of the first application is interrupted.

In some embodiments, the method further includes: interrupting network communication of the first application again if a reading instruction for any message of the first application is not received within a third preset duration after network communication of the first application is recovered.

In some embodiments, the method further includes: recovering network communication of the first application after a fourth preset duration elapses after network communication of the first application is interrupted again, wherein the fourth preset duration is longer than or equal to the second preset duration.

In some embodiments, the step of interrupting network communication of the first application if the reading instruction for any message of the first application is not received within the first preset duration after the first message is received includes: determining a first application type of the first application; and interrupting network communication of the first application and network communication of another application of the first application type if the reading instruction for any message of the first application and a reading instruction for any message of the other application of the first application type are not received within the first preset duration after the first message is received.

In the embodiment of the present disclosure, the first message of the first application is received, the first notice corresponding to the first message is displayed, network communication of the first application is interrupted if the reading instruction for any message of the first application is not received within the first preset duration after the first message is received, and network communication of the first application is recovered when the preset interruption cancellation triggering event is detected. In such a manner, when the user does not need to read a message of a certain application, the terminal may interrupt network communication of the application, preventing reception of the message of the application and further preventing display of a corresponding notice, so that power of the terminal may be saved.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of submodules/subunits.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the disclosure only be limited by the appended claims.

### INDUSTRIAL APPLICABILITY

In the embodiments of the present disclosure, the first message of the first application is received, the first notice corresponding to the first message is displayed, network communication of the first application is interrupted if the reading instruction for any message of the first application is not received within the first preset duration after the first message is received, and network communication of the first application is recovered when the preset interruption cancellation triggering event is detected. In such a manner, when the user does not need to read a message of a certain application, the terminal may interrupt network communication of the application, preventing reception of the message of the application and further preventing display of a corresponding notice, so that power of the terminal may be saved.

What is claimed is:

1. An application management method, comprising:
receiving a first message of a first application, and displaying a first notice corresponding to the first message;
interrupting network communication of the first application if a reading instruction for any message of the first application is not received within a first preset duration after the first message is received; and
recovering network communication of the first application when a preset interruption cancellation triggering event is detected.

2. The method according to claim 1, wherein interrupting network communication of the first application if the reading instruction for any message of the first application is not received within the first preset duration after the first message is received comprises:
interrupting network communication of the first application if a terminal is in a standby state when receiving the first message and if the reading instruction for any message of the first application is not received within the first preset duration after the first message is received.

3. The method according to claim 1, wherein recovering network communication of the first application when the preset interruption cancellation triggering event is detected comprises:
recovering network communication of the first application after the reading instruction for any message of the first application is received.

4. The method according to claim 1, wherein recovering network communication of the first application when the preset interruption cancellation triggering event is detected comprises:
recovering network communication of the first application after a second preset duration elapses after network communication of the first application is interrupted.

5. The method according to claim 4, further comprising:
interrupting network communication of the first application again if the reading instruction for any message of the first application is not received within a third preset duration after network communication of the first application is recovered.

6. The method according to claim 5, further comprising:
recovering network communication of the first application after a fourth preset duration elapses after network communication of the first application is interrupted again, wherein the fourth preset duration is longer than or equal to the second preset duration.

7. The method according to claim 1, wherein interrupting network communication of the first application if the reading instruction for any message of the first application is not received within the first preset duration after the first message is received comprises:
determining a first application type of the first application; and
interrupting network communication of the first application and network communication of another application of the first application type if the reading instruction for any message of the first application and a reading instruction for any message of the other application of the first application type are not received within the first preset duration after the first message is received.

8. An application management device, comprising:
a processor; and
a memory for storing instructions executable by the processor,
wherein the processor is configured to:
receive a first message of a first application, and display a first notice corresponding to the first message;
interrupt network communication of the first application if a reading instruction for any message of the first application is not received within a first preset duration after the first message is received; and
recover network communication of the first application when a preset interruption cancellation triggering event is detected.

9. The device according to claim 8, wherein in order to interrupt network communication of the first application if the reading instruction for any message of the first application is not received within the first preset duration after the first message is received, the processor is configured to:
interrupt network communication of the first application if a terminal is in a standby state when receiving the first message and if the reading instruction for any message of the first application is not received within the first preset duration after the first message is received.

10. The device according to claim 8, wherein in order to recover network communication of the first application when the preset interruption cancellation triggering event is detected, the processor is configured to:
recover network communication of the first application after the reading instruction for any message of the first application is received.

11. The device according to claim 8, wherein in order to recover network communication of the first application when the preset interruption cancellation triggering event is detected, the processor is configured to:
recover network communication of the first application after a second preset duration elapses after network communication of the first application is interrupted.

12. The device according to claim 11, wherein the processor is further configured to:
interrupt network communication of the first application again if the reading instruction for any message of the first application is not received within a third preset duration after network communication of the first application is recovered.

13. The device according to claim 12, wherein the processor is further configured to:
recover network communication of the first application after a fourth preset duration elapses after network communication of the first application is interrupted again, wherein the fourth preset duration is longer than or equal to the second preset duration.

14. The device according to claim 8, wherein in order to interrupt network communication of the first application if the reading instruction for any message of the first application is not received within the first preset duration after the first message is received, the processor is configured to:
determine a first application type of the first application; and
interrupt network communication of the first application and network communication of another application of the first application type if the reading instruction for any message of the first application and a reading instruction for any message of the other application of the first application type are not received within the first preset duration after the first message is received.

15. A non-transitory computer-readable storage medium having stored therein instructions that, when executed by a processor, cause the processor to perform an application management method, the method including:
receiving a first message of a first application, and displaying a first notice corresponding to the first message;
interrupting network communication of the first application if a reading instruction for any message of the first application is not received within a first preset duration after the first message is received; and
recovering network communication of the first application when a preset interruption cancellation triggering event is detected.

16. The non-transitory computer-readable storage medium according to claim 15, wherein interrupting network communication of the first application if the reading instruction for any message of the first application is not received within the first preset duration after the first message is received comprises:
interrupting network communication of the first application if a terminal is in a standby state when receiving the first message and if the reading instruction for any message of the first application is not received within the first preset duration after the first message is received; or
determining a first application type of the first application; and interrupting network communication of the first application and network communication of other application of the first application type if the reading instruction for any message of the first application and a reading instruction for any message of said other application of the first application type are not received within the first preset duration after the first message is received.

17. The non-transitory computer-readable storage medium according to claim 15, wherein recovering network communication of the first application when the preset interruption cancellation triggering event is detected comprises:
recovering network communication of the first application after the reading instruction for any message of the first application is received.

18. The non-transitory computer-readable storage medium according to claim 15, wherein recovering network communication of the first application when the preset interruption cancellation triggering event is detected comprises:
recovering network communication of the first application after a second preset duration elapses after network communication of the first application is interrupted.

19. The non-transitory computer-readable storage medium according to claim 18, the method further comprising:
interrupting network communication of the first application again if the reading instruction for any message of the first application is not received within a third preset duration after network communication of the first application is recovered.

20. The non-transitory computer-readable storage medium according to claim 19, the method further comprising:
recovering network communication of the first application after a fourth preset duration elapses after network communication of the first application is interrupted again, wherein the fourth preset duration is longer than or equal to the second preset duration.
